(19) United States
(12) Patent Application Publication
(10) Pub. No.: US 2024/0193703 A1
(43) Pub. Date: Jun. 13, 2024

(54) INTEGRATING PSYCHOLOGICAL AND EXPERIENCED BASED USER INFORMATION USING DIGITAL FILES ASSOCIATED WITH NON-FUNGIBLE TOKENS

(71) Applicant: MUTUALLY UNITED, INC., Schwenksville, PA (US)

(72) Inventor: Stephen GEDAY, Schwenksville, PA (US)

(73) Assignee: MUTUALLY UNITED, INC., Schwenksville, PA (US)

(21) Appl. No.: 18/555,390

(22) PCT Filed: May 2, 2022
(86) PCT No.: PCT/US2022/027321

§ 371 Date: Oct. 13, 2023

Related U.S. Application Data
(60) Provisional application No. 63/182,253, filed on Apr. 30, 2021.
(60) Provisional application No. 63/319,958, filed on Mar. 15, 2022.

(51) Int. Cl. G06Q 50/00; H04L 67/306

(52) U.S. Cl. CPC G06Q 50/01; H04L 67/306; G06Q 2220/00

(57) ABSTRACT

A method is provided. The method is implemented by a software platform and interface executed by a processor. The method includes analyzing psychological and experienced based user information of user profiles and a current user profile and determining profile connections between the profiles and the current user profile based on the analysis of the psychological and experienced based user information. The method includes presenting an interface comprising a scrollable profile presentation of the profile connections. Each profile of the profile connections is presented in a customized form correlated to the current user profile based on the analysis of the psychological and experienced based user information.

### CROSS REFERENCE TO RELATED APPLICATIONS

This application claims priority from U.S. Provisional Patent Application No. 63/182,253, entitled “SOFTWARE PLATFORM AND INTERFACE INTEGRATING PSYCHOLOGICAL AND EXPERIENCED BASED USER INFORMATION FOR PROFILE CONNECTIONS,” filed on Apr. 30, 2021 and from U.S. Provisional Patent Application No. 63/319,958, entitled “UTILIZING DIGITAL FILES ASSOCIATED WITH NON-FUNGIBLE TOKENS TO PROVIDE PSYCHOLOGICAL AND EXPERIENCED BASED PROFILE CONNECTIONS,” filed on Mar. 15, 2022, which is hereby incorporated by reference as if set forth in full in this application for all purposes.

### FIELD OF INVENTION

The present invention is related to a software platform and interface. More particularly, the present invention relates to integrating psychological and experienced based user information using digital files associated with non-fungible tokens.

### BACKGROUND

Currently, there are presently no techniques for authentic human connections through social media with respect to non-fungible tokens and psychological and experienced based user information.

### SUMMARY

According to one or more embodiments, a method is provided. The method is implemented by a software platform and interface executed by one or more processors. The method includes analyzing psychological and experienced based user information of one or more user profiles and a current user profile and determining one or more profile connections between the one or more user profiles and the current user profile based on the analysis of the psychological and experienced based user information. The method includes presenting an interface comprising a scrollable profile presentation of the one or more profile connections. Each profile of the one or more profile connections is presented in a customized form correlated to the current user profile based on the analysis of the psychological and experienced based user information.

According to one or more embodiments, a system is provided. The system includes a memory storing a software platform and interface as program code and one or more processors executing the program code. The program code causes the system to generate a user interface comprising a pinwheel presentation of user profiles determined based on an analysis of psychological and experienced based user information of the user profiles with respect to a current user profile, the pinwheel presentation configured to free scroll through the user profiles in a clock or counter clock wise direction.

According to one or more embodiments, a system is provided. The system includes a memory storing a software platform and interface as program code and one or more processors executing the program code. The program code causes the system to generate a user interface comprising a heat meter configured to be set to a plurality of settings for each profile of a plurality of user profiles that the program code determined to be a match based on an analysis of psychological and experienced based user information of the plurality of user profiles with respect to a current user profile.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 depicts a method according to one or more embodiments;

FIG. 2 depicts a system according to one or more embodiments;

FIG. 3 depicts a method according to one or more embodiments;

FIG. 4 depicts a system according to one or more embodiments;

FIG. 5 depicts a neural network and a method performed in the neural network according to one or more embodiments;

FIG. 6 depicts a method according to one or more embodiments;

FIG. 7 depicts a diagram of software operations according to one or more embodiments;

FIG. 8 depicts interfaces according to one or more exemplary embodiments;

FIG. 9 depicts an interface according to one or more exemplary embodiments; and

FIG. 10 depicts interfaces according to one or more exemplary embodiments.

### DETAILED DESCRIPTION

Disclosed herein is a software platform and interface. More particularly, the software platform and interface disclosed herein relates to integrating psychological and experienced based user information using digital files associated with non-fungible tokens (NFTs). The software platform and interface, including any digital tools and social media solutions therein, is a processor executable code or instructions that are necessarily rooted in process operations by, and in processing hardware of, a computing device/system/environment.

According to one or more embodiments, the software platform and interface provides digital tools and social media solutions configured to digitally scale and organically forge high value and meaningful connections between profiles (e.g., profile connections). Each profile within the software platform and interface can represent a person and include at least psychological and experienced based user information about that person. The psychological and experienced based user information can include, but is not limited to, proximity data, affinity data, and authenticity data. Proximity data can include a close physical immediacy by correlating a time and a space of the two profiles (e.g., “here and now”). Affinity data can include likes, values, and comforts shared between the two profiles. Authenticity data can include verified activity and/or assertions by the two profiles. A profile connection forged by the software platform and interface can include linking two profiles in view of the psychological and experienced based user information to represent a human connection between two people corresponding to those two profiles.

Further, the software platform and interface uses digital NFT assets to generate the psychological and experienced user information that is leveraged for the profile connections. Each digital NFT asset includes a digital file, such as a photo, a document, a video, etc., and/or an associated NFT. An NFT is a non-interchangeable unit of data stored on a digital ledger, such as a blockchain, that is associated with a digital file. NFTs transform digital files into one-of-a-kind, verifiable assets (e.g., digital NFT assets). In this regard, each NFT enables unique identification and, in turn, sole ownership of a particular digital file, which can then be displayed, tracked, sold, and traded. Further, the software platform and interface can extract and analyze proximity, affinity, and/or authenticity data (e.g., the psychological and experienced based user information about that person) from the digital NFT assets with confidence due to the NFTs.

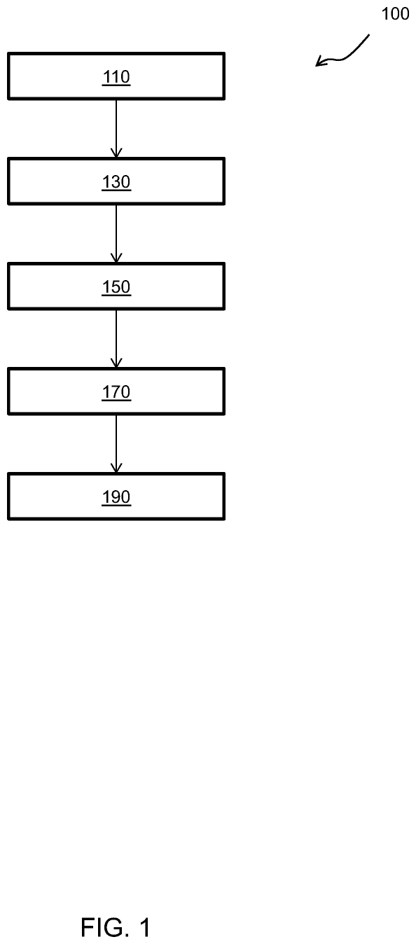

As shown in FIG. 1, a method 100 implemented by the software platform and interface is illustrated according to one or more embodiments. At block 110, the software platform and interface filters one or more user profiles based on a proximity setting of a current user profile to provide a filtered profile set including one or more filtered profiles. The proximity setting can include space and/or time factors.

A space factor is a distance X, Y, Z vector setting at which two or more profiles can be considered proximate to each other. For instance, if distance X, Y, Z vector setting is set to 10 meters, then any user device associated with the current profile can consider other user devices for other user profiles proximate when those other user devices are within 10 meters. In this case, the proximity setting enables the software platform and interface to differentiate whether users are at a relative location, such as on the same floor of a building (10 meters in a Z or vertical direction), at a same area of a concert venue (10 meters in X-Y plane or horizontal direction), etc.

A time factor can be set to seconds or minutes or greater, and can include a range. In this way, if users of the software platform and interface are at a relative location within a specific time factor, then a proximity setting can indicate that those users are proximate (such that if one user is at a same coffee shop within a certain time).

At block 130, the software platform and interface analyzes the one or more filtered profiles of the filtered profile set based on psychological and experienced based user information (e.g., the proximity data, the affinity data, and/or the authenticity data) to determine one or more matches to the current user profile. According to one or more embodiments, the software platform and interface can derive the psychological and experienced based user information from digital NFT assets associated with the current user profile and the one or more user profiles.

At block 150, the software platform and interface presents the one or more matches (e.g., suggests high value and meaningful connections between profiles) in a user interface (UI) of the software platform and interface. A high value connection includes connections that have a greater worth and/or importance in comparison with other connections, where worth and/or importance is determined from the analyze proximity, affinity, and/or authenticity data. A meaningful connection includes connections that provide usefulness for, recognizable function for, and/or contribution towards the current user usefulness, recognizable function, and/or contribution are determined from analyze proximity, affinity, and/or authenticity data. That is, because the psychological and experienced based user information is at the root of the human experience and drive high value and meaningful human connections, the software platform and interface integrates psychological and experienced based user information to infinitely scale human connections (i.e., the one or more matches) for whatever purpose users may find value in.

At block 170, the software platform and interface configures one or more profile connections with respect to the one or more matches (e.g., in response to one or more inputs, the one or more profile connections are established to the current user profile). At block 190, the software platform and interface enables heat meter information to be configured for each of the one or more profile connections through the UI of the software platform. One or more advantages, technical effects, and/or benefits of the software platform and interface can include providing authentic human connections through social media with respect to psychological and experienced based user information. Practical applications of the software platform and interface can include, but is not limited to, being casual observers, forging connections, establishing friendships, dating, and networking.

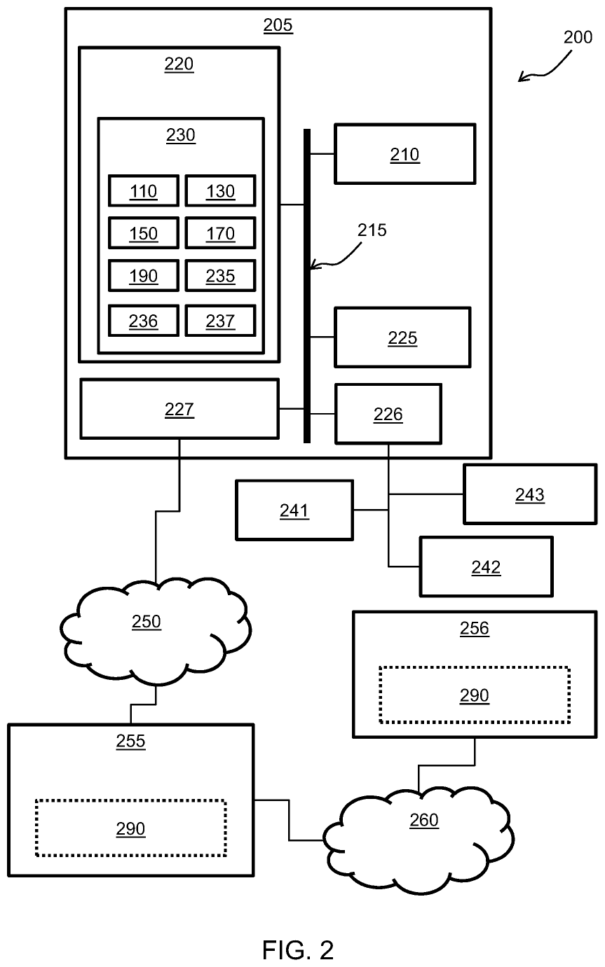

Turning now to FIG. 2, a computing system 200 is illustrated according to one or more embodiments. The computing system 200 can be representative of any computing device, computing apparatus, and/or computing environment, which comprise hardware, software, or a combination thereof. Further, embodiments of the computing system 200 disclosed may include apparatuses, systems, methods, and/or computer program products at any possible technical detail level of integration.

The computing system 200 has a device 205 with one or more central processing units (CPU(s)), which are collectively or generically referred to as a processor 210. The processor 210, also referred to as processing circuits, is coupled via a system bus 215 to a system memory 220 and various other components. The computing system 200 and/or the device 205 may be adapted or configured to perform as an online platform, a server, an embedded computing system, a personal computer, a console, a personal digital assistant (PDA), a cell phone, a tablet computing device, a quantum computing device, cloud computing device, a mobile device, a smartphone, a fixed mobile device, a smart display, a wearable computer, or the like.

The processor 210 may be any type of general or specific purpose processor, including a central processing unit (CPU), application specific integrated circuit (ASIC), field programmable gate array (FPGA), graphics processing unit (GPU), controller, multi-core processing unit, three dimensional processor, quantum computing device, or any combination thereof. The processor 210 may also have multiple processing cores, and at least some of the cores may be configured to perform specific functions. Multi-parallel processing may also be configured. In addition, at least the processor 210 may be a neuromorphic circuit that includes processing elements that mimic biological neurons.

The system bus 215 (or other communication mechanism) is configured for communicating information or data to the processor 210, the system memory 220, and various other components, such as the adapters 225, 226, and 227.

The system memory 220 is an example of a (non-transitory) computer readable storage medium, where software 230 (i.e., the software platform and interface described herein) can be stored as software components, modules, engines, instructions, or the like for execution by the processor 210 to cause the device 205 to operate, such as described herein with reference to the figures. The system memory 220 can include any combination of a read only memory (ROM), a random access memory (RAM), internal or external Flash memory, embedded static-RAM (SRAM), solid-state memory, cache, static storage such as a magnetic or optical disk, or any other types of volatile or non-volatile memory. Non-transitory computer readable storage mediums may be any media that can be accessed by the processor 210 and may include volatile media, non-volatile media, or the like. For example, the ROM is coupled to the system bus 215 and may include a basic input/output system (BIOS), which controls certain basic functions of the device 205, and the RAM is read-write memory coupled to the system bus 215 for use by the processors 210. Non-transitory computer readable storage mediums can include any media that is removable, non-removable, or the like.

According to one or more embodiments, the software 230 can be configured in hardware, software, or a hybrid implementation. The software 230 can be composed of modules that are in operative communication with one another, and to pass information or instructions. According to one or more embodiments, the software 230 can provide one or more UIs, such as on behalf of the operating system or other application and/or directly as needed. The UIs include, but are not limited to, graphic UIs (GUIs), window interfaces, internet browsers, and/or other visual interfaces for applications, operating systems, file folders, and the like. Thus, user activity can include any interaction or manipulation of the UIs provided by the software 230. The software 230 can further include custom modules to perform application specific processes or derivatives thereof, such that the computing system 200 may include additional functionality.

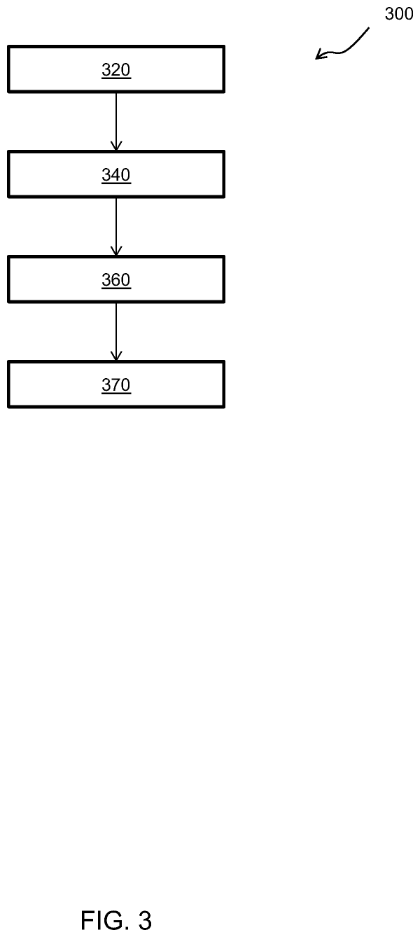

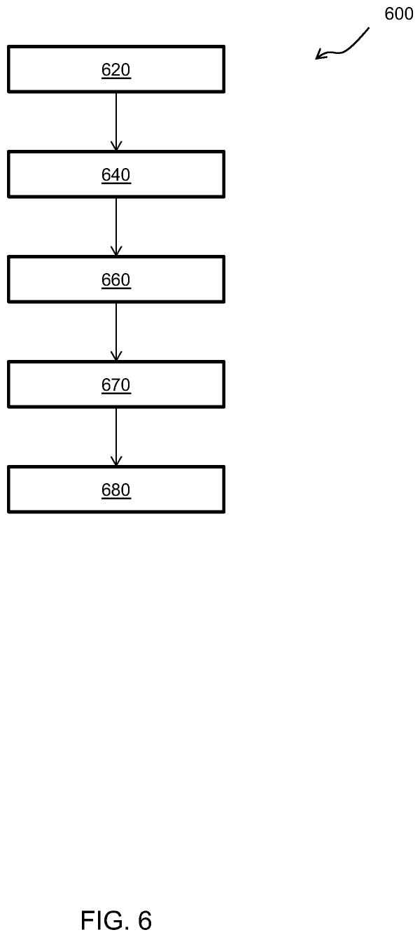

For example, according to one or more embodiments, the software 230 may be configured to store information, instructions, commands, or data to be executed or processed by the processor 210 to logically implement the method 100 of FIG. 1 (as represented by block 110, 130, 150, 170, and 190 within the software 230). Further, the software 230 may be configured to store information, instructions, commands, or data to be executed or processed by the processor 210 to logically implement the methods 300 and 600 of FIGS. 3 and 6 (as represented by block 235 within the software 230), with respect to one or more digital files 236 and digital NFT assets 237 (i.e., a digital file 236 associated with an NFT is a digital NFT asset 237). The software 230 of FIG. 2 can also be representative of an operating system, a mobile application, a client application, and/or the like for the device 205 for the computing system 200.

According to one or more embodiments, the software 230 enables people to connect and socialize based on various grounds and for various reasons. As discussed herein, the various grounds and various reasons are qualified by proximity (e.g., including immediacy), affinity, and/or authenticity data to foster initial and enhanced interactions and the establishment and growth of relationships. That is, the software 230 aids a connection process by automatically providing authorized content for any initial curiosity to occur between proximate users, as the software 230 accounts for the notion that people are more likely to notice, be drawn to, establish an initial basis to other people when they are (physically) close thereto. Further, the software 230 can support a person's reasoning to establish a connection according to a known and shared affinity because the software 230 accounts for that people are more likely to be noticed, intrigued, drawn to each other and more likely to talk or act to establish a connection when people are aware that they have something in common. The technical effect and benefit of the software 230 includes solving the concern that people in close proximity with each other have absolutely no idea about the other people in their vicinity.

According to one or more embodiments, features of the software 230 can provide friend connections and integration with other. The software 230 can enable users to build a connections list of other users. The software 230 can enable users to make, accept, and cancel invitations for their respective invitations list. The software 230 can enable embed into these connections lists the reference and coding to the heat meter results and assignments (described herein).

According to one or more embodiments, features of the software 230 are not designed to operate in isolation. The software 230 is synergized into the continuous user arc, taking random strangers from people watching, through connecting, chatting, sharing their interest in each other, and sharing more intimate details about themselves with one another. The entire time, the software 230 is able to do so from a psychological, emotional, and mental place of security, to enable user to be able to pursue interests, various types of relationships with individuals, and convey their intentions accordingly. The software 230 is organic, spontaneous, rewarding, mutually enriching and satisfying, while minimizing stigma, risk, and fear of rejection. Comprised of multiple unique and features, the software 230 provides an overall experience fusing the features described herein together, while itself being an independently psychologically and technologically unique design.

Further, modules of the software 230 can be implemented as a hardware circuit comprising custom very large scale integration (VLSI) circuits or gate arrays, off-the-shelf semiconductors such as logic chips, transistors, or other discrete components, in programmable hardware devices (e.g., field programmable gate arrays, programmable array logic, programmable logic devices), graphics processing units, or the like. Modules of the software 230 can be at least partially implemented in software for execution by various types of processors. According to one or more embodiments, an identified unit of executable code may include one or more physical or logical blocks of computer instructions that may, for instance, be organized as an object, procedure, routine, subroutine, or function. Executables of an identified module co-located or stored in different locations such that, when joined logically together, comprise the module. A module of executable code may be a single instruction, one or more data structures, one or more data sets, a plurality of instructions, or the like distributed over several different code segments, among different programs, across several memory devices, or the like. Operational or functional data may be identified and illustrated herein within modules of the software 230, and may be embodied in a suitable form and organized within any suitable type of data structure.

Furthermore, modules of the software 230 can also include, but are not limited to, location modules, augmented reality modules, virtual reality modules, blockchain module, and machine learning and/or an artificial intelligence (ML/AI) algorithm modules.

A location module can be configured can be configured to create, build, store, and provide algorithms and models that determine a location of the device 205 and relative distances of other devices comprising user profiles. According to more or more embodiments, the location module can implement location, geosocial networking, spatial navigation, satellite orientation, surveying, distance, direction, and/or time software.

An augmented reality module can be configured to create, build, store, and provide algorithms and models that provide interactive experiences of a real-world environments where objects that reside in the real world are enhanced by computer-generated perceptual information, sometimes across multiple sensory modalities. A virtual reality module can be configured to create, build, store, and provide algorithms and models that simulate experiences similar to or completely different from the real world. According to more or more embodiments, the virtual reality and/or the augmented reality modules can provide augmented, mixed, immersive, and/or text-based virtual reality.

A blockchain module can be configured to create, build, store, and provide algorithms and models that provide records or blocks linked together using cryptography, such that each block contains at least one or more of a cryptographic hash of the previous block (e.g., thereby forming a chain), a timestamp, and transaction data (e.g., social data, connection data, preference data, etc.). The timestamp can identify that the transaction data existed when the block was published to get into its hash. According to one or more, the blockchain module can be a dynamic/evolving user-fed algorithmic implementation (i.e., non-static, administrator-prescriptive viewing/interest algorithm) where users provide activity and preferences (or any inputs described herein). In this regard, user activity and preferences dictate operations of the blockchain module. Additionally, the blockchain module can weight and allocate one or more of the activity and preferences in conjunction with any of the other modules described herein. According to one or more embodiments, the blockchain module of the software 230 can integrate with the one or more digital files 236 and the one or more digital NFT assets 237 of the blockchain to extract and analyze proximity, affinity, and/or authenticity data therefrom. The blockchain module of the software 230 can manage and edit the blockchain so that the digital NFT assets 237 can be provided with the digital files 236 in a virtual scrapbook or other NFT wallet. The blockchain module of the software 230 also provide a marketplace to enable users to post the digital NFT assets 237 (in music, sports, entertainment, anime, etc.), and to also purchase, share, trade, and sell the digital NFT assets 237. Note that because each NFT (i.e., token) is uniquely identifiable, the digital NFT assets 237 differ from blockchain cryptocurrencies. The blockchain module of the software 230 also provide a crypto wallet and/or integrate with blockchain cryptocurrencies.

A ML/AI algorithm module can be configured to create, build, store, and provide algorithms and models that improve automatically through experience, as well as emulate ‘natural’ cognitive abilities of humans. In an example, machine learning software uses training data to build a particular model and to improve that model, while artificial intelligence software perceives an environment (e.g., receives active data) and takes actions (e.g., applies a model) to solve a problem and/or produce an output. Artificial intelligence software can use a model built by humans and/or machine learning software. Artificial intelligence software can further provide feedback to the machine learning software to improve any models thereof. Machine learning and artificial intelligence can exist independently and/or coexist.

According to one or more embodiments, the software 230 can also include and/or implement a pinwheel interface of users (including a nearby mode), personal interests and automatic matching thereof, bold and shy introductions and automatic matching thereof, chat and video integration with other features of the software 230, friend connections and integration with other features of the software 230, heat meter and automatic matching thereof, and unlocking personal interests and inner thoughts. According to one or more embodiments, features of the software 230 can provide chat and video integration with other features. That is, the software 230 can include chat and video features fuse other features of the continuous user arc described herein. Users may communicate via chat and video with each other. The software 230 can integrate a heat meter controls and visibility (described herein) as well as the unlocking of personal/private interests and inner thoughts (described herein) into its chat capability. The software 230 can set up group chats, which can be based on personal/private interests, so multiple users who share such personal/private interests may communicate as a group, all while secure on the software 230, and not having to divulge more about their identities or other contact info. According to one or more embodiments, the software 230 can provide dynamic/organic/constant feedback, where profiles are adaptively presented based on the viewer. According to one or more embodiments, the software 230 can provide a viewing field, such as a map view of concentration of users, a digital version of pub crawl, and/or an integration of a map. According to one or more embodiments, the software 230 can provide commercial advertising that connect establishments and/or professional accounts to users to provide a particular status (e.g., limited release drink tickets). As described herein, the software 230 can provide integrate ML/AI, with respect to search terms, learning what user likes, looping inputs, extract interest based information, etc.

With respect to the adapters 225, 226, and 227 of FIG. 2, the device 205 can particularly include an input/output (I/O) adapter 225, a device adapter 226, and a communications adapter 227. According to one or more embodiments, the I/O adapter 225 can be configured as a small computer system interface (SCSI), of in view of frequency division multiple access (FDMA) single carrier FDMA (SC-FDMA), time division multiple access (TDMA), code division multiple access (CDMA), orthogonal frequency-division multiplexing (OFDM), orthogonal frequency-division multiple access (OFDMA), global system for mobile (GSM) communications, general packet radio service (GPRS), universal mobile telecommunications system (UMTS), cdma2000, wideband CDMA (W-CDMA), high-speed downlink packet access (HSDPA), high-speed uplink packet access (HSUPA), high-speed packet access (HSPA), long term evolution (LTE), LTE Advanced (LTE-A), 802.11x, Wi-Fi, Zigbee, Ultra-WideBand (UWB), 802.16x, 802.15, home Node-B (HnB), Bluetooth, radio frequency identification (RFID), infrared data association (IrDA), near-field communications (NFC), fifth generation (5G), new radio (NR), or any other wireless or wired device/transceiver for communication. The device adapter 226 interconnects input/output devices to the system bus 215, such as a display 241, a keyboard 242, a control device 243, or the like (e.g., a camera, a speaker, etc.).

The communications adapter 226 interconnects the system bus 215 with a network 250, which may be an outside network, enabling the device 205 to communicate data with other such devices (e.g., such as the local computing device 255 and, further, the remote computing system 256 through the network 260). In one embodiment, the adapters 225, 226, and 227 may be connected to one or more I/O buses that are connected to the system bus 215 via an intermediate bus bridge. Suitable I/O buses for connecting peripheral devices such as hard disk controllers, network adapters, and graphics adapters typically include common protocols, such as the Peripheral Component Interconnect (PCI).

The display 241 is configured to provide one or more UIs or graphic UIs (GUIs) that can be captured by and analyzed by the software 230, as the users interacts with the device 205. Examples of the display 241 can include, but are not limited to, a plasma, a liquid crystal display (LCD), a light emitting diode (LED), a field emission display (FED), an organic light emitting diode (OLED) display, a flexible OLED display, a flexible substrate display, a projection display, a 4K display, a high definition (HD) display, a Retina© display, an in-plane switching (IPS) display or the like. The display 241 may be configured as a touch, three dimensional (3D) touch, multi-input touch, or multi-touch display using resistive, capacitive, surface-acoustic wave (SAW) capacitive, infrared, optical imaging, dispersive signal technology, acoustic pulse recognition, frustrated total internal reflection, or the like as understood by one of ordinary skill in the art for input/output (I/O).

The keyboard 242 and the control device 243, such as a computer mouse, a touchpad, a touch screen, a keypad, or the like, may be further coupled to the system bus 215 for input to the device 205. In addition, one or more inputs may be provided to the computing system 200 remotely via another computing system (e.g., the local computing device 255 and/or the remote computing system 256) in communication therewith, or the device 205 may operate autonomously.

According to one or more embodiments, the functionality of the device 205 with respect to the software 230 can also be implemented on the local computing device 255 and/or the remote computing system 256, as represented by separate instances of the software 230. Note that the one or more images (e.g., screenshots) can be stored in a common repository located at the device 205, the local computing device 255, and/or the remote computing system 256 and can be downloaded (on demand) to and/or from each of the device 205, the local computing device 255, and/or the remote computing system 256.

Turning now to FIG. 3, a method 300 (e.g., performed by the software 230 of FIG. 2) is illustrated according to one or more exemplary embodiments. The method 300 addresses a need to make authentic human connections through social media with respect to psychological and experienced based user information by providing a multi-step manipulation of at least digital files associated with NFTs (e.g., digital NFT assets 237) that digitally scales and organically forges high value and meaningful connections between profiles (e.g., profile connections).

The method 300 begins at block 320, where the software 230 implemented on the local computing device 255 and/or the remote computing system 256 provide backend/server services to a plurality of devices 205 executing software 230. According to one or more embodiments, the software 230 can be configured on any device, with respect to any operating system. In this regard, any operations of the software 230 can be offloaded to the software 230 and vice versa. The backend/server services can at least include the operations describe herein with respect to the location modules, augmented reality modules, virtual reality modules, blockchain module, and (ML/AI) algorithm modules. By way of example, backend/server services can include extracting and analyzing proximity, affinity, and/or authenticity data from the digital NFT assets 237.

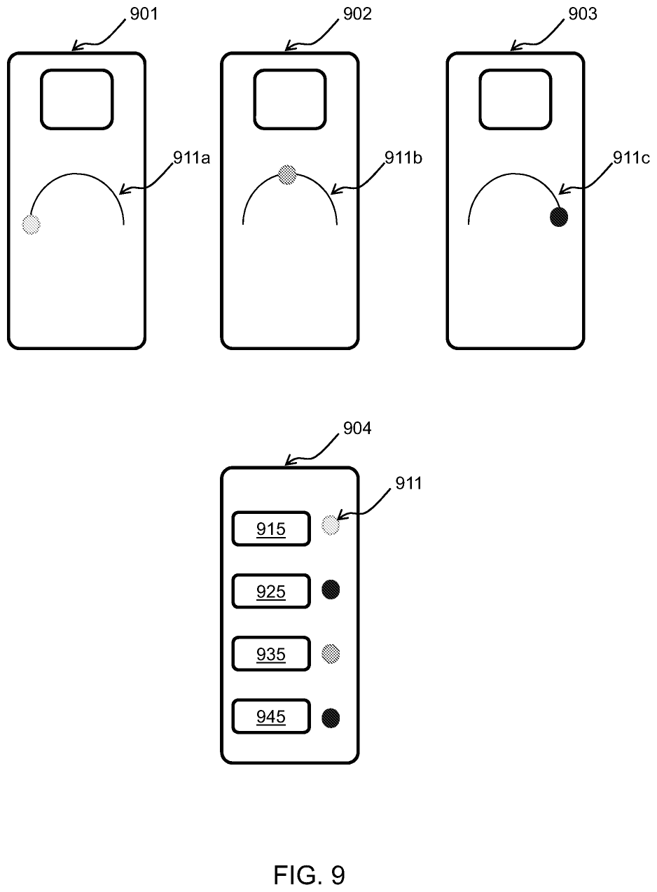

At block 340, the software 230 provides a UI, such as through a mobile application. According to one or more embodiments, the software 230 can be accessed through an ‘app store’ or via a landing page. Once downloaded and installed, the UI can be provided through or on the display 241 for profile building and the like (i.e., the software 230 enables a creation of a current profile representing a user who owns the device 205). The UI of the software 230 overcomes any technical shortcomings of current social media applications/tools (e.g., linear feed with continuous scrolling and/or swiping; binary/static user information; overwhelming providing of user causing nervousness) by at least introducing a set of features and information to a new user, examples and operations of the which are provided with respect to FIGS. 9-12. Once the new user becomes experienced, the software 230 can provide additional information and additional features.

At block 360, with the UI provided in in block 340, the software 230 analyzes the current profile to generate the proximity data, the affinity data, and the authenticity data. By way of example, the software 230 analyzes proximity (e.g., time and space) over distance, recency over stale, interests with respect to quantity vs. quality, interests with respect to personal vs public, etc. In this regard, the software 230 recognizes and overcomes that current social media applications/tools of social landscapes have failed to successfully integrate some of the most powerful psychological bases (e.g., proximity, affinity, and authenticity data) rooted in the human experience that drives human connection.

For instance, regarding proximity data, the software 230 can be configured to utilize academic and professional peer reviewed psychological studies to leverage that humans are more likely to favorably view and forge bonds with others as a consequence of being in closer physical proximity with each other. By contrast, when current social media applications/tools reduce the importance of proximity, humans feel great angst and experience negative psychological, mental, and emotional consequences. According to one or more embodiments, proximity data can include time thresholds, where attendance is measure based on arrival, how long, and departure metrics according to the time and distance factors. The digital NFT asset 237 can provide proximity data by validating attendance (e.g., actual presence), as well as time stamps associated therewith for when and how long a user attended.

Further, regarding affinity data, the software 230 can be configured to leverage that humans find value and comfort in connections with each other when affinity is shared. Affinity data is extracted by the software 203 based on a user's interests, viewpoints, proclivities, attitudes, philosophies, tastes, hobbies, opinions, or experiences (i.e., likes, values, and comforts). Note that affinity is determinable, as well as controllable, by virtue of the public and personal manner of input of interests. The digital NFT assets 237 can provide affinity data by validating and/or supporting likes, values, and comforts (e.g., admiration for dogs). By way of example, the greater the quantity and/or the quality of shared affinities, the more likely, more valuable, and more intense a connection is likely to be. Two users who annually attend the same dog show and have a collection of digital NFT assets 237 validating this admiration can be matched accordingly.

Further, regarding authenticity data, the software 230 can be configured to leverage the notion that being authentic is a third glue of human connections. When people share their authentic nature with each other, as opposed to a more manicured, generalized, public facing version of themselves, deeper connections are more likely to be formed, especially/at least when those authentic characteristics are shared, welcomed, or well received. When humans feel that they are experiencing a fake, concealing, or contrived version of each other, intimate, high value connections wane. Humans are not static, one-dimensional entities, whereby a public profile may vividly capture their essence as a means to connect with others via their respective public profiles. Instead, humans are multi-layered, complex, dynamic beings, who find favor, feel, conceal, and reveal various aspects of themselves for a myriad of reasons and motivations. When an individual voluntarily divulges a deeper, more hidden or secretive layer of themselves to another, the other individual is more likely to recognize and appreciate that authenticity, and reward that expression with a sliver of their authentic self in turn. As a result, it is also more likely for a chain effect to be set in motion, whereby more meaningful and more authentic, inward traits are mutually revealed, thus nourishing and deepening the bond between those two individuals (authenticity can be fostered by linking people with others who truly share traits and interests and they are able to divulge more personal layers of themselves). The appreciation of realizing the other's vulnerability by sharing this information furthers this glue, and trust is more likely to be fashioned. Thus, authenticity data can include verified activity and/or assertions. In an example, the digital NFT assets 237 can provide authenticity data by validating a participation (e.g., in breast cancer charity run), as described herein (the authenticity data is derived from at the digital NFT assets 237). That is, a user cannot assert that a user is part of an activity or belief without consistent evidence showing participation. Thus, posts with validating digital NFT assets 237 provide an authenticated feed and give priority to filtering/searching (e.g., each digital NFT assets 237 raises an authenticity of a user profile). According to one or more embodiments, one or more technical effects, advantages, and/or benefits of the software 230 include fostering authenticity by integrating the digital NFT assets 237.

At block 370, the software 230 determines one or more matches between the one or more user profiles and the current user profile based on the proximity data, the affinity data, or the authenticity data. The one or more matches suggest high value and meaningful connections between the one or more user profiles and the current user profile.

According to one or more embodiments, the software 230 can be configured to analyze factors for matching. Proximity data can be analyzed. The proximity data can include a close physical immediacy by correlating a time factor and a space factor of the two profiles (e.g., “here and now” or “right here, right now”). For instance, two users attend the same concert or the same marathon. However, if these two users attended at different times of the day, then they may not be considered proximate. Furthermore, proximate data can include the space factor (e.g., X, Y, Z coordinate). In this regard, two users may have been in the same venue for a concert; however, if one user was in the front row (e.g., at a first X, Y, Z coordinate) and another user was in a sky box (e.g., at a second X, Y, Z coordinate separated from the first X, Y, Z coordinate by a 6 vertical stories), then the two users may not be considered proximate. Additionally, if a user is in a coffee shop with another user at eh same time, then the users are proximate. In this way, a confluence of time and space result within the user being proximate (e.g., in “Fishbowl” or “In the room” together). As soon one of users leave, then the users are distant (e.g., which means they are “The Sea” or “Out there” respectively and correspondingly excluded from each other's “Fishbowl” or “In the room”).

Affinity and authenticity data can be analyzed. For instance, the possession of a digital NFT asset 237 indicates that a person received and/or purchased a particular digital file and does not possess the digital file by accident. In turn, a facade of possession is impossible and subterfuge is far less likely as a person has to ‘put their money where their mouth is’, rather than simply stating that a person likes the topic associated with the digital NFT asset 237. In this way, a display of one digital NFT asset 237 vs. twenty digital NFT assets 237 corresponding to a particular topic conveys far more accurately an extent and significance of that topic in the user's life. Further, users may more aptly conclude traits and characteristics of other individuals from the digital NFT assets 237 possession than photos (which can be far more contrived, faked, or doctored) or stated hobbies/interests. The ‘trust’ in the veracity of the NFT itself as well as its linkage to the digital file and the owner is far less in dispute, which eliminates ‘catfishing’ or profile manipulation that more commonly exists in the current social media applications/tools (manicured highlight reels that have come to be associated with social media can now be authenticated by an accurate scrapbook/wallet display of the digital NFT asset 237 collected through the years). Thus, the software 230 utilizes the digital NFT assets 237 to determine affinity and authenticity by counting a number of digital NFT assets 237 to determine an amount of affinity and correlating each digital NFT asset 237 with actual events to determine claims of participation or ownership.

Thus, the technical effects and benefits of the method 300 include enabling harnessing these aspect of proximity, affinity, and authenticity data. Further, one or more technical effects, advantages, and/or benefits of the software 230 include fostering authenticity by integrating the digital NFT assets 237.

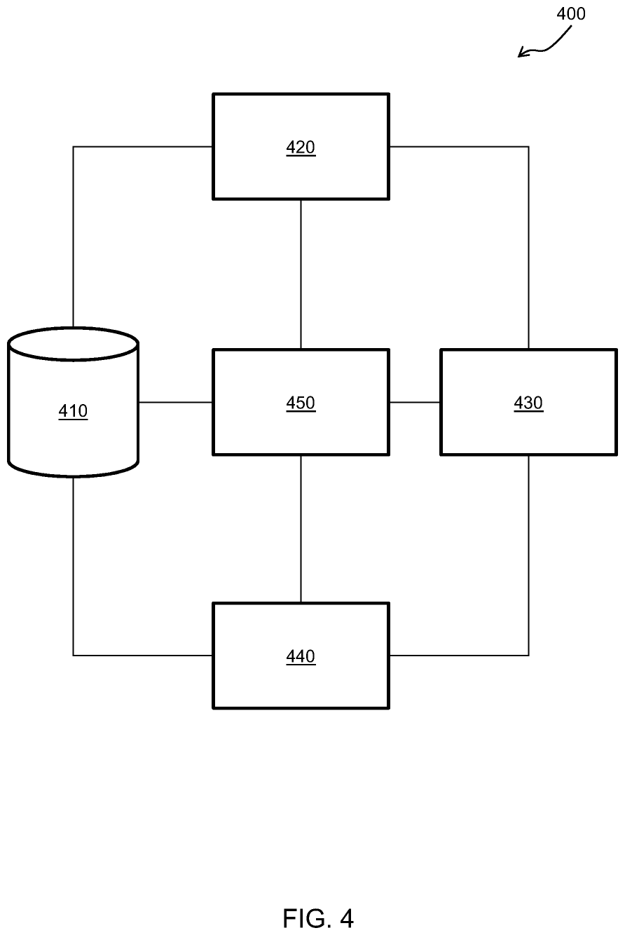

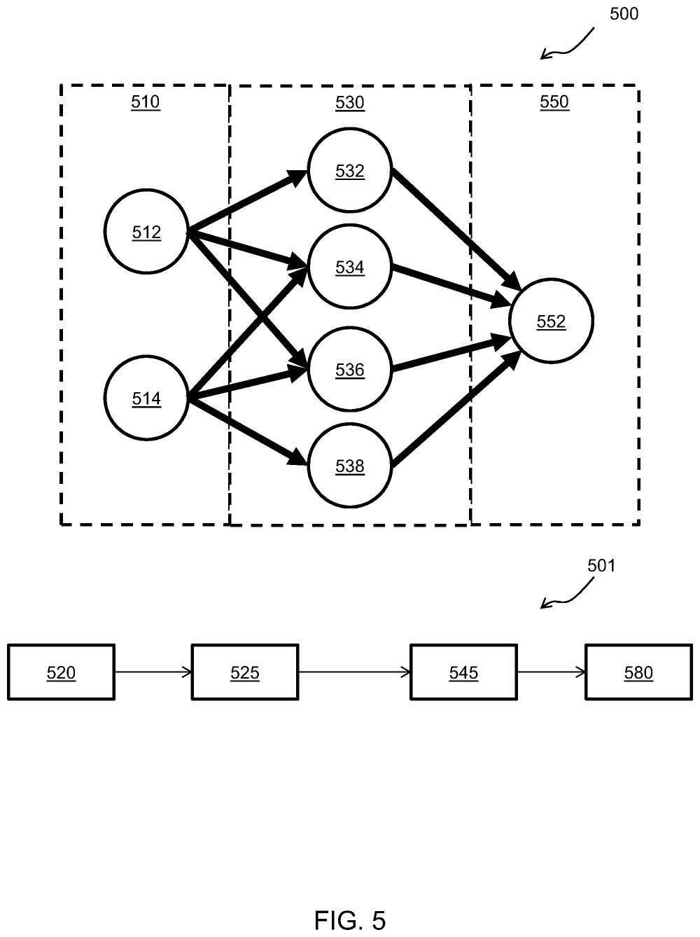

Turning to FIGS. 4-5, the software 230 utilizes the ML/AI algorithm module to implement and/or support the method according to one or more embodiments. FIG. 4 illustrates a graphical depiction of an artificial intelligence system 400 according to one or more embodiments. The artificial intelligence system 400 includes data 410, a machine 420, a model 430, an outcome 440, and (underlying) hardware 450. The description of FIGS. 4-5 is made with reference to FIGS. 1-3 for ease of understanding where appropriate. For example, the machine 420, the model 430, and the hardware 450 can represent aspects of the software 230 of FIG. 2 (e.g., ML/AI algorithm module therein), while the hardware 450 can also represent the device 205 of FIG. 2. In general, the machine learning and/or the artificial intelligence algorithms of the artificial intelligence system 400 (e.g., as implemented by the software 230 of FIG. 2) operate with respect to the hardware 450, using the data 410, to train the machine 420, build the model 430, and predict the outcomes 440.

For instance, the machine 420 operates as the controller or data collection associated with the hardware 450 and/or is associated therewith. The data 410 can be on-going data or output data associated with the hardware 450. The data 410 can also include currently collected data, historical data, or other data from the hardware 450 and can be related to the hardware 450. The data 410 can be divided by the machine 420 into one or more subsets. As an example, the data 410 can be one or more user profiles and information associated therewith (e.g., the proximity data, the affinity data, and the authenticity data of the psychological and experienced based user information).

Further, the machine 420 trains, such as with respect to the hardware 450. This training can also include an analysis and correlation of the data 410 collected. In accordance with another embodiment, training the machine 420 can include self-training by the software 230 of FIG. 2 utilizing the one or more subsets. In this regard, the software 230 of FIG. 2 learns to detect, extract, and generate the profile connections, the proximity data, the affinity data, the authenticity data, and heat meter information.

Moreover, the model 430 is built on the data 410 associated with the hardware 450. Building the model 430 can include physical hardware or software modeling, algorithmic modeling, and/or the like that seeks to represent the data 410 (or subsets thereof) that has been collected and trained. In some aspects, building of the model 430 is part of self-training operations by the machine 420. The model 430 can be configured to model the operation of hardware 450 and model the data 410 collected from the hardware 450 to predict the outcome 440 achieved by the hardware 450. Predicting the outcomes 440 (of the model 430 associated with the hardware 450) can utilize a trained model 430. Thus, using the outcome 440 that is predicted, the machine 420, the model 430, and the hardware 450 can be configured accordingly.

Thus, for the artificial intelligence system 400 to operate with respect to the hardware 450, using the data 410, to train the machine 420, build the model 430, and predict the outcomes 440, the machine learning and/or the artificial intelligence algorithms therein can include neural networks. In general, a neural network is a network or circuit of neurons, or in a modern sense, an artificial neural network (ANN), composed of artificial neurons or nodes or cells.

For example, an ANN involves a network of processing elements (artificial neurons) which can exhibit complex global behavior, determined by the connections between the processing elements and element parameters. These connections of the network or circuit of neurons are modeled as weights. A positive weight reflects an excitatory connection, while negative values mean inhibitory connections. Inputs are modified by a weight and summed using a linear combination. An activation function may control the amplitude of the output. For example, an acceptable range of output is usually between 0 and 1, or it could be −1 and 1. In most cases, the ANN is an adaptive system that changes its structure based on external or internal information that flows through the network.

In more practical terms, neural networks are non-linear statistical data modeling or decision-making tools that can be used to model complex relationships between inputs and outputs or to find patterns in data. Thus, ANNs may be used for predictive modeling and adaptive control applications, while being trained via a dataset. Note that self-learning resulting from experience can occur within ANNs, which can derive conclusions from a complex and seemingly unrelated set of information. The utility of artificial neural network models lies in the fact that they can be used to infer a function from observations and also to use it. Unsupervised neural networks can also be used to learn representations of the input that capture the salient characteristics of the input distribution, and more recently, deep learning algorithms, which can implicitly learn the distribution function of the observed data. Learning in neural networks is particularly useful in applications where the complexity of the data or task makes the design of such functions by hand impractical.

Neural networks can be used in different fields. Thus, for the artificial intelligence system 400, the machine learning and/or the artificial intelligence algorithms therein can include neural networks that are divided generally according to tasks to which they are applied. These divisions tend to fall within the following categories: regression analysis (e.g., function approximation) including time series prediction and modeling; classification including pattern and sequence recognition; novelty detection and sequential decision making; data processing including filtering; clustering; blind signal separation, and compression. For example, application areas of ANNs include nonlinear system identification and control (vehicle control, process control), game-playing and decision making (backgammon, chess, racing), pattern recognition (radar systems, face identification, object recognition), sequence recognition (gesture, speech, handwritten text recognition), financial applications, data mining (or knowledge discovery in databases, “KDD”), visualization and e-mail spam filtering.

According to one or more embodiments, the neural network can implement a long short-term memory neural network architecture, a convolutional neural network (CNN) architecture, or other the like. The neural network can be configurable with respect to a number of layers, a number of connections (e.g., encoder/decoder connections), a regularization technique (e.g., dropout); and an optimization feature.

The long short-term memory neural network architecture includes feedback connections and can process single data points (e.g., such as images), along with entire sequences of data (e.g., such as speech or video). A unit of the long short-term memory neural network architecture can be composed of a cell, an input gate, an output gate, and a forget gate, where the cell remembers values over arbitrary time intervals and the gates regulate a flow of information into and out of the cell.

The CNN architecture is a shared-weight architecture with translation invariance characteristics where each neuron in one layer is connected to all neurons in the next layer. The regularization technique of the CNN architecture can take advantage of the hierarchical pattern in data and assemble more complex patterns using smaller and simpler patterns. If the neural network implements the CNN architecture, other configurable aspects of the architecture can include a number of filters at each stage, kernel size, a number of kernels per layer.

Turning now to FIG. 5, an example of a neural network 500 and a block diagram of a method 501 performed in the neural network 500 are shown according to one or more embodiments. The neural network 500 operates to support implementation of the machine learning and/or the artificial intelligence algorithms (e.g., as implemented by the software 230 of FIG. 2) described herein. The neural network 500 can be implemented in hardware, such as the machine 420 and/or the hardware 450 of FIG. 4. As indicated herein, the description of FIGS. 4-5 is made with reference to FIGS. 1-3 for ease of understanding where appropriate.

In an example operation, the software 230 of FIG. 2 includes collecting the data 410 from the hardware 450. In the neural network 500, an input layer 510 is represented by a plurality of inputs (e.g., inputs 512 and 514 of FIG. 5). With respect to block 520 of the method 501, the input layer 510 receives the inputs 512 and 514.

At block 525 of the method 501, the neural network 500 encodes the inputs 512 and 514 utilizing any portion of the data 410 (e.g., the dataset and predictions produced by the artificial intelligence system 400) to produce a latent representation or data coding. The latent representation includes one or more intermediary data representations derived from the plurality of inputs. According to one or more embodiments, the latent representation is generated by an element-wise activation function (e.g., a sigmoid function or a rectified linear unit) of the software 230 of FIG. 2. As shown in FIG. 5, the inputs 512 and 514 are provided to a hidden layer 530 depicted as including nodes 532, 534, 536, and 538. The neural network 500 performs the processing via the hidden layer 530 of the nodes 532, 534, 536, and 538 to exhibit complex global behavior, determined by the connections between the processing elements and element parameters. Thus, the transition between layers 510 and 530 can be considered an encoder stage that takes the inputs 512 and 514 and transfers it to a deep neural network (within layer 530) to learn some smaller representation of the input (e.g., a resulting the latent representation).

The deep neural network can be a CNN, a long short-term memory neural network, a fully connected neural network, or combination thereof. This encoding provides a dimensionality reduction of the inputs 512 and 514. Dimensionality reduction is a process of reducing the number of random variables (of the inputs 512 and 514) under consideration by obtaining a set of principal variables. For instance, dimensionality reduction can be a feature extraction that transforms data (e.g., the inputs 512 and 514) from a high-dimensional space (e.g., more than 10 dimensions) to a lower-dimensional space (e.g., 2-3 dimensions). The technical effects and benefits of dimensionality reduction include reducing time and storage space requirements for the data 410, improving visualization of the data 410, and improving parameter interpretation for machine learning. This data transformation can be linear or nonlinear. The operations of receiving (block 520) and encoding (block 525) can be considered a data preparation portion of the multi-step data manipulation by the software 230.

At block 545 of the method 510, the neural network 500 decodes the latent representation. The decoding stage takes the encoder output (e.g., the resulting the latent representation) and attempts to reconstruct some form of the inputs 512 and 514 using another deep neural network. In this regard, the nodes 532, 534, 536, and 538 are combined to produce in the output layer 550 an output 552, as shown in block 560 of the method 510. That is, the output layer 590 reconstructs the inputs 512 and 514 on a reduced dimension but without the signal interferences, signal artifacts, and signal noise.

Turning to FIG. 6, a method 600 (e.g., performed by the software 230 of FIG. 2) is illustrated according to one or more exemplary embodiments. The method 600 addresses a need to make authentic human connections through social media with respect to psychological and experienced based user information by providing a multi-step manipulation of at least digital files associated with NFTs (e.g., digital NFT assets 237) that digitally scales and organically forges high value and meaningful connections between profiles (e.g., profile connections). The method 600 is described with reference to FIGS. 6-19, which illustrate one or more exemplary diagrams and interfaces according to one or more exemplary embodiments.

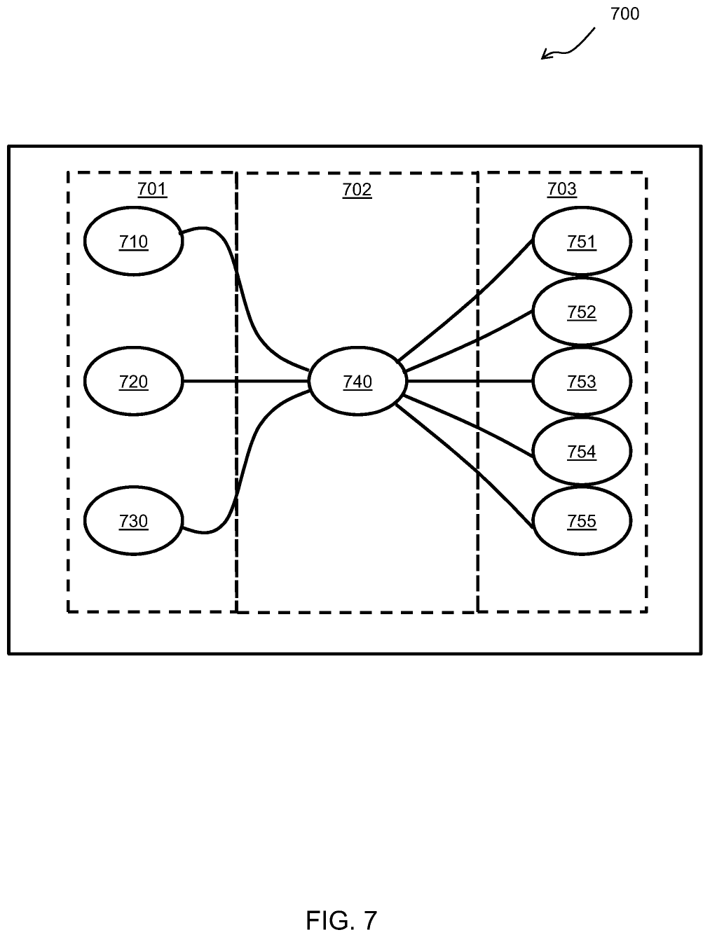

Generally, as shown by the diagram 700 of FIG. 7, the method 600 generates profile connections to revolutionize human connections across a framework of psychology 701, technology 702, and infinite scale 703. In diagram 700, the framework of the software 230 implements a continuous arc through the technology 702 to provide human connections based on the psychology 701 and the infinite scale 703. In this regard, the psychology 701 of proximity data 710, affinity data 720, and authenticity data 730 are utilized by the technology 702 (i.e., the software 230 implementing the method 600) across the infinite scale 703 of different types of connections. The connection types include, but are not limited to, strangers and casual connections 751, new connections 752, friends 753, dating 754, and networking 755.

The method 620 being at block 620, where the software 230 analyzes psychological and experienced based user information of one or more user profiles and a current user profile. The psychological and experienced based user information includes proximity data, affinity data, or authenticity data. The proximity data, affinity data, or authenticity data is extracted from one or more digital non-fungible token (NFT) assets associated with any of the one or more user profiles and the current user profile. Each of the one or more digital NFT assets comprises a digital file and a NFT that certifies the digital file. For example, with respect to psychology 701, the digital files 236 and the digital NFT assets 237 can be utilized to show and verify proximity based on real time purchases of or acquisitions, as well as time stamps (e.g., information associated with a digital audio file associated with an NFT verifies physical real time presence at a concert). Further, the digital files 236 and the digital NFT assets 237 can be utilized to show and verify affinity based ownership (e.g., information associated with an image file associated with an NFT purchased at a muscle car convention verifies a user's likes, values, etc. muscle cars). Furthermore, the digital files 236 and the digital NFT assets 237 can be utilized to show and verify authenticity based real time ownership (e.g., information associated with an ticketing file associated with an NFT purchased to participate in a breast cancer charity run authenticates a user's attendance).

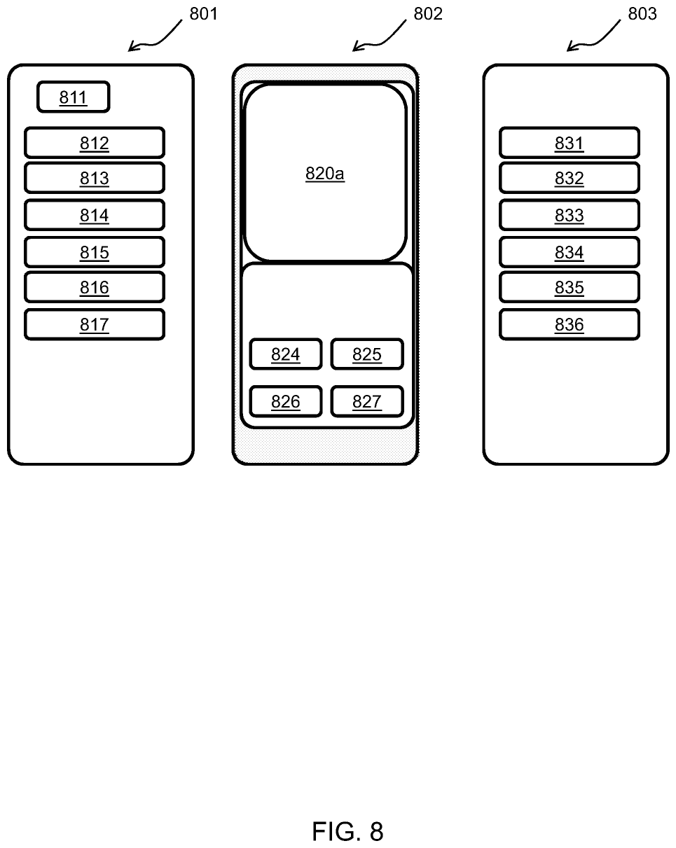

As shown in interfaces 801, 802, and 803 of FIG. 8, the software 230 can provide personal interests and automatic matching thereof. For instance, when building a profile, the software 230 enabled inputs, such as name 812, age 813, profile image 814, public interests 815, personal interest 816 (e.g., also known as “private Interests”, which is in contrast to “public interests”), and NFT assets 817. In turn, the software 230 can provide usage, display, and notification of the personal interests 816. At interface 802, users may populate their profiles with individually user fed personal interests 816, which are only visible to other users if those users share the same interest. For example, if User A has “Space Research” 824 as a personal interest with associated digital NFT assets 825 and 826, User B will only see these interests on User A's profile if User B has “Space Research” somewhere in his/her profile's interests list (either publicly or privately). Vice versa, User A would see “Space Research” on User B's profile because User A shares this interest. The rest of the population of users would not see “Space Research” on either User A's or User B's profiles, unless of course such other user shared the same interest. Users public interests 827, by contrast, are visible in all relevant search views where their profile would appear. For all interests, users input them at the time of initial sign up and onboarding during profile creation, and have the ability to add to, delete, and edit their interests in their profile settings. The software 230 compiles all these users, their interests, and their corresponding parameters (public or personal) as data points, and matches and reveals them to users per the above logic. In addition, as shown in interface 803, users may opt to permit notifications in their settings, which then causes the software 230 to notify via push notifications or other user chosen methods, the users if other users who share relevant interests (designated by the primary user in question) to them. Examples of notifications include, but are not limited to, al in-app notifications 831, new message notifications 832, greeting notifications 833, digital NFT asset matching notifications 834, message thread expiration notifications 835, and potential nearby match 836. That is, User A may set up his/her notifications preferences for the software 230 to notify him/her if another user who is interested in “Space Research” is in proximate mode distance. Thus, users may dial specifically into what they are seeking on a more personal level, or even be notified when they are not actively engaged in using the software 230. Users see public interests highlighted in a more prominent color when they are held in common with the user they are viewing, so as to stand out and be noticed. In accordance with one or more embodiments, notifications can accommodate notifying when a User B is nearby to User A (e.g., respective to a certain distance threshold) and/or has the same specified interests as User A. According to one or more embodiments, the software 230 can deploy additional manual safeguards, whereby a User's personal interests won't be automatically made known to other users (even matching interested users), but rather only the fact that they share a personal interest will, and then the user will have the option to unlock the content of that specific personal interest. According to one or more embodiments, a user can selectively reveal, conceal, and/or re-conceal or -reveal personal interests/inner thoughts as described herein.

At block 640, the software 230 determines one or more profile connections between the one or more user profiles and the current user profile based on the analysis of the psychological and experienced based user information. Based on the one or more profile connections, the software 230 enables a current user to people watch through a pinwheel view of nearby users, provide reasons to connect and ice breaking information through automatic personal interest matching, and initiate bold or shy hellos that trigger particular chats or views in accordance with reciprocal behavior. Further, the software 230 enables a current user to initiate video or chat features and connect with other users based on heat meter information, as well as reveal inner or personal thoughts. With respect to unlocking personal interests and inner thoughts along with providing public information, the software 230 offers an “Inner Thoughts” secondary description that a user may create about him/herself. By way of example, the “Inner Thoughts” secondary description is a block of text is created by the user about him/herself. No other users see the “Inner thoughts” unless the user manually releases this feature to a given, selected other user. A user may unlock these inner thoughts to any other users, and if done, that other user may see the inner thoughts section. Just like unlocking one's own inner thoughts to another user, a user may also choose to unlock additional personal/private interests to another user, and designate which if any other personal/private interests that user may see. These would be the same type of personal/private interests described herein, but unlike matching personal/private interests which are automatically visible to the corresponding user who shares those interests, this feature allows a user to show another user his/her personal/private interests voluntarily, even if those interests are not matching or shared. The principle and purpose of unlocking inner thoughts and additional personal/private interests is that users may reveal personal and revealing aspects of themselves, so as to bond and connect further, and so as to invite similar revelatory behavior from that other user.

At block 660, the software 230 filters the one or more profile connections based on a proximity setting of the current user profile to provide a filtered profile set. The proximity setting comprises an immediacy factor and a space factor. The filtered profile set can be viewable through the pinwheel user interface. The filtering of the one or more profile connections proximity includes determining immediacy and space confluences between the one or more user profiles and the current user profile in view of the proximity setting. For example, if User 1 has “Coffee” as a personal interest that is authenticated with a digital NFT asset, User 2 will only see the User 1's profile if User 2 and User 1 are authenticated at the same location and the same time in accordance with a proximity setting.

At block 670, the software 230 utilizes heat meter information to determine the one or more profile connections between the one or more user profiles and the current user profile. FIG. 9 depicts interfaces 901, 902, 903, and 904 according to one or more exemplary embodiments 829. The interfaces 901, 902, 903, and 904 depict operations of the software 230 with respect to a heat meter 911 and heat meter information, as well as automatic matching with respect to both. The heat meter 911 enables uses to set how they feel about another user between a plurality of settings. In an example, three settings can be used, such as normal, friends, and interested. Thus, users are able to indicate their level of interest to other users discreetly, so that no one, including the other user in question, knows, unless and until the intended user feels the same way about the primary user.

For purposes of explanation, User A and User B are two users amidst all of the users on the software 230. All users start at a baseline, normal status on the heat meter 911, which is depicted as a semicircular arc in FIG. 9. Heat meter information reflects a setting of the heat meter 911 based on position of a selector on the arc. Baseline/normal position 911a is all the way to the left at the bottom, with the position of the setting selector and the coloring indicating that position. User A feels like elevating the “heat” of the relationship with User B to “Friends”. User A moves the heat meter 911 setting by sliding the selector with the touch of a finger upward toward the middle apex position 911b on the arc to the “Friends” position, which is also indicated by a different color (e.g., a darker shade of grey or a pastel green). At this point in time, no other user, including User B, is aware of User A's action. However, User B would receive a notice, similar to a “Shy Hi”, advising that someone felt like “Friends” with User B. User B would not know who felt this way, but would have to use the software 230 to find out. If User B were to perform the same action on his/her end regarding User A, then the mutual interest in each other as “Friends” would be made known to them both, and the corresponding “Friends” color (e.g., the darker shade of grey or the pastel green) would appear by that other user's profile and information throughout the software 230. That is, User A would see User B's heat meter color symbol as the pastel green, and User B would see User A's heat meter color symbol as the pastel green. Other third party users would have no knowledge about what transpired between Users A and B. If User B did not reciprocate this action to User A as described, then User B would remain unaware of User A's intentions. Both users would still see the default baseline status on each other. Only User A would know that in his/her settings, he/she had placed his heat meter dial for User B on “Friends”, where he/she may allow it to remain or move it up or down. If User A desired to further elevate the setting of the heat meter 911 of User B to “Interested”, then the process would unfold just as with “Friends.” User A would have to manually move the setting of the heat meter 911 by sliding the selector with the touch of a finger further, all the way to the right bottom corner of the heat meter arc to the “Interested” position 911c, which is also indicated by yet a different color (e.g., a black circle or a pastel red). At this point in time, no other user, including User B, is aware of User A's action. However, User B would receive a notice, similar to a “Shy Hi”, advising that someone felt “Interested” in User B. User B would not know who felt this way, but would have to use the software 230 to find out. If User B were to perform the same action on his/her end regarding User A, then the mutual interest in each other as “Interested” would be made known to them both, and the corresponding “Interested” color (e.g., pastel red) would appear by that other user's profile and information throughout the software 230. That is, User A would see User B's heat meter color symbols as red, and User B would see User A's heat meter color symbols as red. Other third party users would still have no knowledge about what transpired between Users A and B. If User B did not reciprocate this action to User A as described, then User B would remain unaware of User A's intentions. Only User A would know that in his/her settings, he/she had placed his heat meter dial for User B on “Interested”, where he/she may allow it to remain or move it up or down. It is possible to bypass the “Friends” setting and proceed straight to “Interested”. If, for example, User A placed his/her heat meter setting for User B straight to “Interested”, but User B did nothing, no changes would take place, and User B would still be unaware of User A's intentions. User B would have been notified that some use felt Interested in User B. On the other hand, if for example, User A placed his/her heat meter setting straight to “Interested”, but User B placed his/her heat meter setting for User A to “Friends”, then both parties would be notified of the highest mutual matching level, which in this case would only be “Friends”. And thus, for Users A and B the mutual interest in each other as “Friends” would be made known to them both, and the corresponding “Friends” color (e.g., the pastel green) would appear by that other user's profile and information throughout the software 230. That is, User A would see User B's heat meter color symbol as green, and User B would see User A's heat meter color symbol as green. Other third party users would still have no knowledge about what transpired between Users A and B. According to one or more embodiments, there can be a higher level beyond “Interested”, such as “Passionate”. The heat meter principles remain the same. Users will be notified in a general sense that someone (not knowing who) placed them on a certain setting. Only when there is a match of the same heat meter setting will the two relevant users be alerted to the pairing of the same interest, which will always be the highest mutual interested. That is, Friends and Friends: Friends is the highest mutual interest; Friends and Interested: Friends is the highest mutual interest; Interested and Interested: Interested is the highest mutual interest; and Friends and Passionate: Friends is the highest mutual interest. For example, the heat meter controls and the viewing of the highest mutual interest is accessible and integrated throughout the software 230 by virtue of the assigned colors to each heat meter setting. As shown in interface 904, when viewing users 915, 925, 935, and 945, the heat meters 911 can be respectively shown for each of these users.

At block 680, the software 230 presents a UI including a scrollable profile presentation of the one or more profile connections. Each profile of the one or more profile connections is presented in a customized form correlated to the current user profile based on the analysis of the psychological and experienced based user information. The UI presents a selected profile and a profile feed comprising at least one or more digital NFT assets upon selection of one of the one or more profile connections presented by the scrollable profile presentation. The scrollable profile presentation presents a digital NFT asset as a profile picture for a profile of the one or more profile connections, and wherein the scrollable profile presentation comprises a pinwheel presentation.

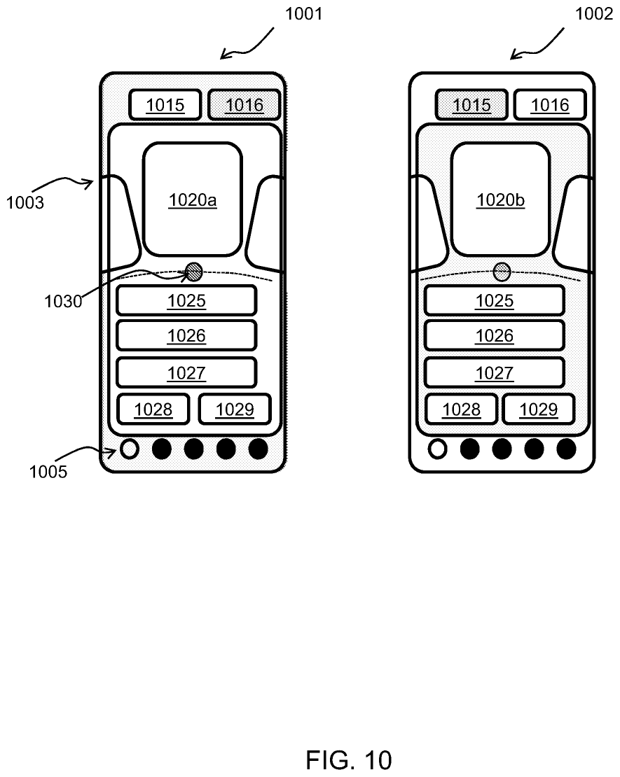

Turing it FIG. 10, interfaces 1001 and 1002 are shown according to one or more exemplary embodiments. As shown in FIG. 10, the software 230 can provide a menu bar 1005 where a first selectable icon can be a search menu. Upon selection of the search menu, the software 230 can provide a pinwheel view 1003 of users. The pinwheel view 1003 of users can be manipulated according to at least two viewing zones, such as a selectable proximate view 1015 and a selectable distant view 1016 (e.g., “Fishbowl” and “The Sea” respectively or “In the room” and “Out there”). The proximate view 1015 enables users to view profiles of users close by them. Using a combination of hyper-specific GPS technology in smartphones and a controlled radius setting, users see other users in that defined radius. This radius can be initially set along a range of distance (e.g., as 1000 feet or 300 yards, essentially a football field or city block), and can be pared down as the user population grows. The unique feature of the proximate view 1015 is that users can digitally people watch who is around and nearby them, seeing their profile photos (e.g., a picture or a digital NFT asset), name/nickname, age if displayed publicly, digital NFT assets, and interests. According to one or more embodiments, the software 230 can implement one or more algorithms as described herein for the one or more views (e.g., filtering the user profiles based on a proximity setting of a current user profile to provide a filtered profile set). For example, in the proximate view 1015, users see and browse everyone in that set radius, nearby them. As the user population grows, filters may be embedded in future releases in the proximate viewing zone. In the distant view 1016, users may control who they see by filtering for radius, gender and age preferences, and interests.

According to one or more embodiments, the pinwheel view 1003 presents users with a pinwheel, free scrolling view of other users, so a current user may browse, a.k.a. ‘people watch’ other users. The one or more profile connections are arranged in the backend in a circular arrangement, so that a left or right finger motion on a lead, central profile creates a clockwise or counterclockwise scroll through the profiles. As the profiles (e.g., the digital files 236 and/or the digital NFT assets 237) scroll through the central frame, contained within a viewing screen of a phone, accompanying profile information/ingredients similarly track and appear. That, as each profile of the pinwheel settles into a center of the interface 1001 or 1002, additional information is provided by the software 230. According to one or more embodiments with respect to pinwheel browsing via the pinwheel view 1003 of users, the users eventually connect in an aggregated circle, digitally existing in the backend, but visually, only the main one in central frame appears somewhat larger, while the neighboring profiles to the left and right of the central profile appear partially in view, and somewhat smaller. Pinwheel browsing can provide dynamic/organic constant feedback, where profiles are adaptively presented based on the viewer. Example operations of the pinwheel (e.g., a specialized a browsing window) include wheeling/scrolling and expanding and collapsing profiles. The software can determine who the viewer browses and who they are most likely to come back to. Note that the viewer can switch views between proximate 1015 and distant 1016. The software 230 can define (e.g., algorithm defined) the proximate/fishbowl, while the distant/sea can be everyone and then filtered. AR/VR can be applied by the software 230 such that an adaptive design where the viewer can see different sides of people is presented. Thus, the software 230 can squeeze a diverse tapestry of human experience in different pictures (e.g., infuse the tapestry of human internet rather than binary presentation) and digitize the organic-ness of human connections (A to B is different than A to C). According to one or more embodiments, the digital files 236 and the digital NFT assets 237 can be leveraged by the software within the pinwheel view of nearby neighbors (e.g., proximity matching), for automatic matching of personal interests (e.g., affinity matching), for verifying inner thoughts and interests (e.g., providing authenticity), etc. Thus, operations and actions within and by the software 230 minimize or potentially even eliminate certain social, psychological, and emotional risks that may otherwise typically exist.

As shown in FIG. 10, each profile presents a picture 1020 (e.g., picture profiles, the digital files 236, and/or the digital NFT assets 237), identifying information 1025 (e.g., name, age, etc.), public interests 1026, private interests 1027, first hello 1028, second hello 1029, and heat meter 1030. The public interests 1026 show information about a profile that are readily discoverable. The private interests 1027 show information about a profile that are discoverable based on a high value and meaningful match. The first hello 1028 can be considered a bold introduction, and the second hello 1029 can be considered a shy introduction. Not that aspects of the “Bold/Shy” introductions can be labeled or implemented using alternative nomenclature and/or shorthand images, such as “Chat now” and “Let's see,” respectively. According to one or more embodiments, once a user has viewed the profile of another user and has the desire to try to establish a conversation or connection, he/she may do so by one or more methods. For example, a method includes sending a “Bold Hi”, by selecting the first hello 1028, that drives the sending user's “Bold Hi” right to the receiving user's inbound notification area and initiates a chat. Another method includes sending a “Shy Hi”, by selecting the second hello 1029 that sends the initiating user's “Shy Hi” to the receiving user's inbound notification area, but does not notify the receiving users as to the identity of the sending user. Instead, the receiving user now knows that some other user has sent them a shy hello, but they have no idea who sent it. The only way to find out is to reciprocate by sending shy Hl's in similar fashion. Once the two individuals successfully have “Shy Hi'd” each other, the software 230 pairs these hello's, provides a celebratory splash notice screen, and provides the natural next action suggestion by way of clicking on a continue button to initiate a chat.

According to one or more embodiments, the software 230 achieves a goal of a cross-versatile experience where user's post, view, comment, interact, etc. with each other's a profile feed, which can include at least digital NFT assets 237. Generally, authenticity is an attractive phenomena that fosters trust and therefore permits better quality profile connections. When users ‘feel’ that they are seeing and experiencing real traits of another, more genuine qualities, and especially qualities that are perhaps not openly known to the rest of the world, these users are more likely to reveal similar traits (e.g., in turn, offer up a more authentic/genuine version of themselves and forge bonds that are cyclically more authentic, deep, and meaningful). The ability to differentiate authenticity from posing or posturing (or even outright lying) is implemented through the blockchain as described herein. The software 230 implements this leveraging by relying on psychological and experienced based user information (from proximity, affinity, and authenticity data), as well as sources and trustworthiness of the user information. Consciously, strategically, subconsciously, and/or out of various forms of desire, users put forth information about themselves to the world in various forms that establish indicia for others' views of them and establish a bases for on-ramps to interactions. These interactions may range from distant observation, closer observation, limited interaction, or more in depth interaction. Items and tokens that users wear, possess, display, or otherwise manifest, convey representation of themselves, which they may embrace or unwittingly convey. For example, the extravagance of clothes, jewelry, cars; the content, brand or style associated thereof; and the explicit or implicit assumptions conveyed thereof, all affect human connections. Other examples include bumper stickers, stickers placed on laptops, and tattoos. An individual's t-shirt design may communicate preferred sports teams, places visite, political ideologies, attitudes about life and culture, and more. Watches, cars, and brand name fashion choices are customarily displayed to communicate wealth, status, power, or even the exaggerated quality thereof. Depending on the user, the setting, the users associated that use, the user inclination, or even a temporary mood, users may choose to communicate by displaying tokens in an outwardly public manner, a subtle personal manner, or a private manner. For example, a user may choose to wear an expensive watch to a business meeting when status is important for deal making, while the same user may choose to wear a less expensive watch when on vacation to keep a lower profile. Note that it can be common for users, especially when aided by these display tokens, to notice each other, form conclusions or assumptions based on the tokens, form desires to interact based on tokens, feel a shared common ground based on the tokens, initiate contact based on the tokens, or scale or deepen their connection based on the tokens. For example, users may feel socio-economically situated by like brands or jewelry, with having visited a same vacation site observed on bumper sticker, sharing a favorite sport, team, or culture (all derived from the tokens). The software 230 utilizes the digital NFT assets 237 to extend these observations and connections to the digital world. In this way, the software 230 solves current problems where the digital world is not associated with proximity despite geographic selectors (i.e., zip code, city, region, or more narrowly, within a certain radius of oneself in miles). Current social media applications/tools, while using linked datapoints have yet to solve how to implement the immediacy of time and proximity. Similarly, while a thirst by users for authenticity has not waned, users are limited in how they represent and brand themselves by current social media applications/tools. For instance, users may wonder if a car behind a user in a picture on a social platform is really owned by the user, or just photographed as a passerby experience in a parking lot. Further, a user may see another use post pictures at a certain event that was an isolated attendance and does not truly reflect another user's inclinations. The software 230 solves the problems of whether pictures are recent, are reflective, are filtered, etc. because the software 230 animates proximity (e.g., immediacy), affinity, and authenticity principles through at least the digital NFT assets 237. As users reveal more about themselves, both automatically through auto display of matching public and personal interests, and manually through selectively revealing other personal interests and their inner thoughts, the proximity (e.g., immediacy), affinity, and authenticity principles by the software 230 are imbued in the profile connection process. For instance, integration of the digital NFT assets 237 by the software 230 into the viewing and connection interfaces furthers psychological and connective goals and phenomena for users. By no longer relying on manual alpha-numerical input (i.e., typing in their interests) or self-selected photographs/videos for display, the software 230 integrates the display of the digital NFT assets 237 from NFT wallets, as well as preserves choices and selectivity. The software 230 enables users to choose to display of public digital NFT assets 237 and/or personal digital NFT assets 237 with typed and stated interests. Other users are then able to see and act based upon the digital NFT assets 237.

According to one or more embodiments, a method is provided. The method is implemented by a software platform and interface executed by one or more processors. The method includes filtering one or more user profiles based on a proximity setting of a current user profile to provide a filtered profile set including one or more filtered profiles; analyzing the one or more filtered profiles of the filtered profile set based on psychological and experienced based user information to determine one or more matches to the current user profile; presenting the one or more matches in a user interface of the software platform and interface; and configuring one or more profile connections with respect to the one or more matches.

According to one or more embodiments or any of the method embodiments herein, the psychological and experienced based user information can include proximity data, affinity data, or authenticity data.

According to one or more embodiments or any of the method embodiments herein, the software platform and interface can configure the one or more profile connections in response to one or more inputs and establishes the one or more profile connections to the current user profile.

According to one or more embodiments or any of the method embodiments herein, the software platform and interface can provide authentic human connections through social media with respect to the psychological and experienced based user information.

According to one or more embodiments or any of the method embodiments herein, the software platform and interface can analyze heat meter information to be configured for each of the one or more profile connections through the user interface of the software platform.

According to one or more embodiments or any of the method embodiments herein, the software platform and interface can provide a pin wheel user interface for the one or more profile connections.

According to one or more embodiments or any of the method embodiments herein, the proximity setting can include time and/or space factors.

According to one or more embodiments or any of the method embodiments herein, the one or more matches can suggest high value and meaningful connections between the one or more user profiles.

According to one or more embodiments, a system is provided. The system includes a memory storing a software platform and interface as program code and one or more processors executing the program code to cause the system to perform filtering one or more user profiles based on a proximity setting (e.g., time and/or space factors) of a current user profile to provide a filtered profile set including one or more filtered profiles, analyzing the one or more filtered profiles of the filtered profile set based on psychological and experienced based user information to determine one or more matches to the current user profile, presenting the one or more matches (e.g., suggests high value and meaningful connections between profiles) in a user interface of the software platform and interface, configuring one or more profile connections with respect to the one or more matches.

According to one or more embodiments or any of the system embodiments herein, the psychological and experienced based user information can include proximity data, affinity data, or authenticity data.

According to one or more embodiments or any of the system embodiments herein, the software platform and interface can configure the one or more profile connections in response to one or more inputs and establishes the one or more profile connections to the current user profile.

According to one or more embodiments or any of the system embodiments herein, the software platform and interface can provide authentic human connections through social media with respect to the psychological and experienced based user information.

According to one or more embodiments or any of the system embodiments herein, the software platform and interface can analyze heat meter information to be configured for each of the one or more profile connections through the user interface of the software platform.

According to one or more embodiments or any of the system embodiments herein, the software platform and interface can provide a pin wheel user interface for the one or more profile connections.

According to one or more embodiments or any of the system embodiments herein, the proximity setting can include time and/or space factors.

According to one or more embodiments or any of the system embodiments herein, the one or more matches can suggest high value and meaningful connections between the one or more user profiles.

According to one or more embodiments, a method is implemented by a software platform and interface executed by one or more processors. The method includes analyzing one or more digital files of one or more user profiles and a current user profile to generate proximity data, affinity data, or authenticity data. The method includes determining one or more matches between the one or more user profiles and the current user profile based on the proximity data, the affinity data, or the authenticity data. The method includes presenting a user interface in accordance with the one or more matches or the proximity data, affinity data, or authenticity data.

According to one or more embodiments or any of the method embodiments herein, the method can further include filtering the one or more user profiles based on a proximity setting of a current user profile to provide a filtered profile set including one or more filtered profiles.

According to one or more embodiments or any of the method embodiments herein, the proximity setting can include time and space factors.

According to one or more embodiments or any of the method embodiments herein, the software platform and interface can provide a pinwheel user interface for the one or more matches.

According to one or more embodiments or any of the method embodiments herein, the one or more matches can suggest high value and meaningful connections between the one or more user profiles and the current user profile.

According to one or more embodiments or any of the method embodiments herein, one of the one or more digital files can be associated with a NFT to provide a digital NFT asset.

According to one or more embodiments or any of the method embodiments herein, the authenticity data can be derived by the software platform and interface from at least the digital NFT asset.

According to one or more embodiments or any of the method embodiments herein, the proximity data can include an immediacy that correlates a time and a space confluence of the one or more user profiles and the current user profile.

According to one or more embodiments or any of the method embodiments herein, the user interface of the software platform and interface can present a profile feed for each of the one or more matches, and the profile feed can include at least one or more digital non-fungible token (NFT) assets.

According to one or more embodiments or any of the method embodiments herein, wherein the proximity data, the affinity data, or the authenticity data provide psychological and experienced.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. A computer readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire

Examples of computer-readable media include electrical signals (transmitted over wired or wireless connections) and computer-readable storage media. Examples of computer-readable storage media include, but are not limited to, a register, cache memory, semiconductor memory devices, magnetic media such as internal hard disks and removable disks, magneto-optical media, optical media such as compact disks (CD) and digital versatile disks (DVDs), a random access memory (RAM), a read-only memory (ROM), an erasable programmable read-only memory (EPROM or Flash memory), a static random access memory (SRAM), and a memory stick. A processor in association with software may be used to implement a radio frequency transceiver for use in a terminal, base station, or any host computer.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
analyzing, by a software platform and interface executed by one or more processors, psychological and experienced based user information of one or more user profiles and a current user profile;
determining, by the software platform and interface, one or more profile connections between the one or more user profiles and the current user profile based on the analysis of the psychological and experienced based user information; and
presenting, by the software platform and interface, an interface comprising a scrollable profile presentation of the one or more profile connections, wherein each profile of the one or more profile connections is presented in a customized form correlated to the current user profile based on the analysis of the psychological and experienced based user information.

2. The method of claim 1, wherein the psychological and experienced based user information comprises proximity data, affinity data, or authenticity data.

3. The method of claim 2, wherein the proximity data, affinity data, or authenticity data is extracted from one or more digital non-fungible token (NFT) assets associated with any of the one or more user profiles and the current user profile.

4. The method of claim 3, wherein each of the one or more digital NFT assets comprises a digital file and a NFT that certifies the digital file.

5. The method of claim 1, further comprising:
filtering the one or more profile connections based on a proximity setting of the current user profile to provide a filtered profile set viewable through a pinwheel user interface.

6. The method of claim 5, wherein the proximity setting comprises an immediacy factor and a space factor.

7. The method of claim 5, wherein the filtering of the one or more profile connections proximity comprises determining immediacy and space confluences between the one or more user profiles and the current user profile in view of the proximity setting.

8. The method of claim 1, further comprising:
utilizing heat meter information to determine the one or more profile connections between the one or more user profiles and the current user profile.

9. The method of claim 1, wherein the user interface presents a selected profile and a profile feed comprising at least one or more digital non-fungible token (NFT) assets upon selection of one of the one or more profile connections presented by the scrollable profile presentation.

10. The method of claim 1, wherein the scrollable profile presentation presents a digital NFT asset as a profile picture for a profile of the one or more profile connections, and wherein the scrollable profile presentation comprises a pinwheel presentation.

11. A system comprising:
a memory storing a software platform and interface as program code; and
one or more processors executing the program code to cause the system to perform:
generating a user interface comprising a pinwheel presentation of user profiles determined based on an analysis of psychological and experienced based user information of the user profiles with respect to a current user profile, the pinwheel presentation configured to free scroll through the user profiles in a clock or counter clock wise direction.

12. The system of claim 11, wherein a left or right finger motion on a lead, central profile creates a clockwise or counterclockwise scroll through the user profiles.

13. The system of claim 11, wherein a profile in a central frame of a viewing screen of a phone is accompanied by profile information of that profile.

14. The system of claim 11, wherein user interface is configured to switch between proximate and distant view.

15. The system of claim 11, wherein the pinwheel presentation configured present one or more digital non-fungible token (NFT) assets associated with the user profiles.

16. The system of claim 11, wherein the psychological and experienced based user information comprises proximity data, affinity data, or authenticity data.

17. A system comprising:
a memory storing a software platform and interface as program code; and
one or more processors executing the program code to cause the system to perform:
generating a user interface comprising a heat meter configured to be set to a plurality of settings for each profile of a plurality of user profiles that the program code determined to be a match based on an analysis of psychological and experienced based user information of the plurality of user profiles with respect to a current user profile.

18. The system of claim 17, wherein the plurality of settings include normal, friends, and interested.

19. The system of claim 17, wherein the heat meter comprises an arc and heat meter information reflects a setting of the heat meter based on position of a selector on the arc.

20. The system of claim 17, wherein the psychological and experienced based user information comprises proximity data, affinity data, or authenticity data.
